(19) United States
(12) Patent Application Publication
(10) Pub. No.: US 2026/0312018 A1
(43) Pub. Date: Oct. 8, 2026

(54) SECONDARY BATTERY

(71) Applicant: Prime Planet Energy & Solutions, Inc., Tokyo (JP)

(72) Inventor: Kouhei MASAI, Kobe-shi (JP)

(21) Appl. No.: 19/636,915

(22) Filed: Apr. 2, 2026

(30) Foreign Application Priority Data
Apr. 4, 2025 (JP) 2025-062249

(51) Int. Cl. H01M 4/36; H01M 4/02; H01M 4/525; H01M 10/0525

(52) U.S. Cl. CPC H01M 4/366; H01M 4/525; H01M 2004/021; H01M 2004/028; H01M 10/0525

(57) ABSTRACT

A secondary battery disclosed herein includes a cathode, an anode, and a nonaqueous electrolytic solution. The cathode includes a cathode current collector and a cathode active material layer on the cathode current collector. The cathode active material layer includes a first layer and a second layer, and the first layer is located between the cathode current collector and the second layer. The first layer includes first cathode active material particles, and the second layer includes second cathode active material particles. The second cathode active material particles have an average particle strength of 190 MPa or higher, which is higher than that of the first cathode active material particle. The second cathode active material particles have an average sphericity of 0.95 or higher.

### CROSS REFERENCE TO RELATED APPLICATION

This application claims priority based on Japanese Patent Application No. 2025-062249 filed on Apr. 4, 2025, which is entirely incorporated herein by reference.

### BACKGROUND

The present disclosure relates to a secondary battery.

In recent years, rechargeable secondary batteries such as lithium ion secondary batteries have been used as portable power sources for mobile devices or the like and as vehicle drive power sources for electric vehicles (EV), hybrid electric vehicles (HEV), plug-in hybrid electric vehicles (PHEV), or the like.

A secondary battery includes an assembly, as an electrode body, having electrodes (cathode, anode) responsible for a battery reaction during charging and discharging. The cathode has e.g. a sheet-like current collector and a cathode active material layer on the current collector. The cathode is prepared e.g. by applying a cathode slurry onto both sides of the current collector, followed by drying and pressing the resulting coating film. The electrode slurry primarily contains particulate cathode active material. The drying makes it possible to remove liquid components from the coating film on the current collector to form a cathode active material layer. For the pressing, e.g. a pair of press rolls is used. By the pressing, the cathode active material layer is compressed between the press rolls in the thickness direction on the current collector to increase a capacity density of the cathode. Such a technology for secondary batteries is described e.g. in Japanese Patent Application Publication No. 2023-167298.

In the above pressing step in the cathode preparation process, a high load acts on the cathode active material layer on the current collector. Thereby, the cathode active material particles in the layer are cracked (press cracking) in some cases. At positions having the press cracking on the cathode active material particles, new exposed surfaces are generated (newly generated surfaces), and, for example, during a high-temperature storage test for the secondary battery, gas may be generated due to contact between the surfaces and an electrolytic solution, or the like. Such gas generation is undesirable because it reduces in the battery capacity, or the like.

### SUMMARY

The present disclosure has been invented under the above circumstances, and an object of the present disclosure is to provide a secondary battery suitable for reducing gas generation amount in a cathode while maintaining an energy density.

The secondary battery disclosed herein includes a cathode, an anode, and a nonaqueous electrolytic solution. The cathode includes a current collector and a cathode active material layer on the current collector. The cathode active material layer includes a first layer and a second layer, and the first layer is located between the current collector and the second layer. The first layer contains first cathode active material particles. The second layer contains second cathode active material particles. The second cathode active material particles have an average particle strength of 190 MPa or higher, which is higher than that of the first cathode active material particles. The second cathode active material particles have an average sphericity of 0.95 or higher. The secondary battery having such a configuration is suitable for reducing gas generation amount in the cathode while maintaining the energy density. The reason for this is considered to be as follows.

In the cathode active material layer (including the first layer and second layer in this order from the current collector side) of the above secondary battery, as described above, the second cathode active material particles in the second layer have an average particle strength of 190 MPa or higher, which is higher than that of the first cathode active material particles in the first layer. This helps to suppress the press cracking of the cathode active material particles in the second layer (closer to the press roll than the first layer), where the load from the press roll (press load) is more likely to concentrate than in the first layer, in the pressing step aforementioned for the prior art. The suppression of the press cracking on the cathode active material particles, or suppression of the generation and increase of the newly generated surfaces described above, is suitable for reducing the gas generation described above.

Furthermore, as described above, the second cathode active material particles in the second layer have an average sphericity of 0.95 or higher. This helps to ensure the slipperiness between the second cathode active material particles in the second layer and to relieve the press load that acts on the second cathode active material particles. The relief of the press load on the second cathode active material particles helps to suppress the press cracking of the particles to reduce the aforementioned gas generation.

Furthermore, the first layer of the cathode active material layer contains the first cathode active material particles, which are flexible because of their lower average particle strength than that of the second cathode active material particles in the second layer. This helps to relieve the press load on the second layer in the aforementioned pressing step, because the first layer functionally serves as a cushion between the current collector and the second layer. The relief of the press load on the second layer helps to suppress the press cracking of the cathode active material particles in the second layer to reduce the aforementioned gas generation.

Furthermore, the first cathode active material particles, which are flexible because of their lower average particle strength compared to the second cathode active material particles, are more easily deformed by the press load and have higher fillability (more easily densified) than the second cathode active material particles. The cathode active material layer including the first layer containing such cathode active material particles is suitable for ensuring a high capacity density in the cathode active material layer or the cathode, and therefore suitable for ensuring a high energy density in the secondary battery.

As described above, the secondary battery having the above configuration is suitable for reducing the gas generation in the cathode while ensuring the energy density.

Preferably, the average particle strength of the first cathode active material particles is 160 MPa or lower. This configuration is preferable for ensuring both the aforementioned cushioning function of the first layer in the cathode active material layer and the aforementioned fillability of the first cathode active material particles.

Preferably, the second cathode active material particle has a surface layer portion enriched with at least one element selected from the group consisting of Group 6 elements and Group 13 elements.

Preferably, the ratio of the element selected from the group consisting of Group 6 elements and Group 13 elements to the total amount of Ni, Co, and Mn in the second cathode active material particle is 0.8 mol % or higher and 3.0 mol % or lower. The element selected from Group 6 elements and Group 13 elements is preferably tungsten. These configurations are suitable for achieving a high average particle strength for the second cathode active material particles.

Preferably, the ratio of the element selected from Group 6 elements and Group 13 elements to the total amount of Ni, Co, and Mn in the first cathode active material particle is lower than 0.8 mol %. This configuration is preferable for ensuring the aforementioned cushioning function of the first layer in the cathode active material layer and the aforementioned fillability of the first cathode active material particles.

Preferably, the ratio of the thickness of the second layer to the total thickness of the cathode active material layer is 5% or higher and 65% or lower. This configuration is preferable for achieving a good balance between the ensuring of the energy density and the reduction of the gas generation in the cathode.

Preferably, the first cathode active material particles have an average particle diameter D₅₀ of 5 μm or larger and 18 μm or smaller. This configuration is preferable for ensuring the aforementioned cushioning function of the first layer and the aforementioned fillability of the first cathode active material particles in the cathode active material layer.

Preferably, the second cathode active material particles have an average particle diameter D₅₀ of 3 μm or larger and 15 μm or smaller. This configuration is preferable for ensuring the fillability of the second cathode active material particles in the second layer.

Preferably, the cathode active material constituting the first cathode active material particles and/or second cathode active material particles is a lithium composite oxide having a composition represented by a constitution formula Li(LiₐNiₓCo_{y}Mn_{z}M_{α})O₂ [wherein −0.1≤a≤0.1, 0.7≤x≤1, 0≤y≤0.3, 0≤z≤0.3, x+y+z=1, 0≤α≤0.1, and M is at least one element selected from the group consisting of B, Al, Mg, Ca, Ti, V, Cr, Ga, Zr, Nb, Mo, In, Hf, Ta, W, and Ti]. A lithium composite oxide having such a composition is suitable for achieving a high energy density as a cathode active material in a secondary battery.

### BRIEF DESCRIPTION OF THE DRAWINGS

FIG. 1 is a schematic sectional view illustrating an internal structure of a secondary battery according to an embodiment of the present invention;

FIG. 2 is a schematic diagram illustrating a configuration of an electrode body provided in the secondary battery in FIG. 1; and

FIG. 3 is a schematic sectional view of a cathode of the electrode body in FIG. 2, with some parts omitted.

### DETAILED DESCRIPTION OF THE PREFERRED EMBODIMENTS

A lithium ion secondary battery as an embodiment of the secondary battery according to the present invention will be explained with reference to the drawings. Note that matters that are not specifically mentioned herein but necessary for implementing the present invention (e.g. general configuration and manufacturing process of a secondary battery that does not characterize the present invention) can be understood as matters designed by those skilled in the art on the basis of the prior art in the field. The present invention can be implemented based on the content disclosed herein and the common technical knowledge in the field. Furthermore, in the following drawings, members and portions having same effects are marked with same reference signs for explanation. The dimensional relationships (e.g. length, width, thickness) in each drawing do not necessarily reflect actual dimensional relationships. In this specification, the term “secondary battery” refers to a general rechargeable power storage device, encompassing so-called storage batteries and power storage elements such as electric double-layer capacitors.

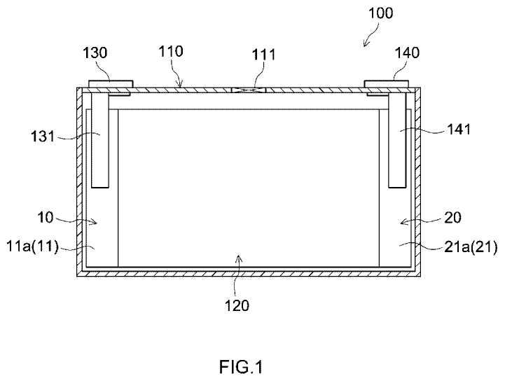

FIG. 1 is a schematic sectional view illustrating an internal structure of a secondary battery 100 according to an embodiment of the present invention. The secondary battery 100 includes a battery case 110, an electrode body 120 (electrode assembly), a cathode terminal 130 (positive terminal), an anode terminal 140 (negative terminal), and a nonaqueous electrolytic solution (not illustrated). In this embodiment, the secondary battery 100 is a lithium ion secondary battery.

The battery case 110 is a housing for the secondary battery 100 and accommodates the electrode body 120 and the nonaqueous electrolytic solution. In this embodiment, the battery case 110 has a flat and rectangular parallelepiped (e.g. square) outer shape. Examples of constituent materials for the battery case 110 include aluminum, an aluminum alloy, iron, and an iron alloy. From the viewpoint of achieving both weight saving and a desired rigidity for the battery case 110, the constituent material for the battery case 110 is preferably aluminum or an aluminum alloy.

In this embodiment, the battery case 110 includes a safety valve 111. In this embodiment, the safety valve 111 is located between the cathode terminal 130 and the anode terminal 140 on the top surface of the battery case 110 in FIG. 1. The safety valve 111 is a thin-walled portion configured to rupture when a gas pressure inside the battery case 110 rises above a predetermined value. When the safety valve 111 ruptures, the gas inside the battery case 110 is discharged outside the battery case 110 to prevent or suppress additional pressurization inside the battery case 110. Furthermore, the battery case 110 has an injection hole (not illustrated) for injecting a nonaqueous electrolytic solution into the battery case 110. The injection hole is sealed by a sealing member after injection of the nonaqueous electrolytic solution.

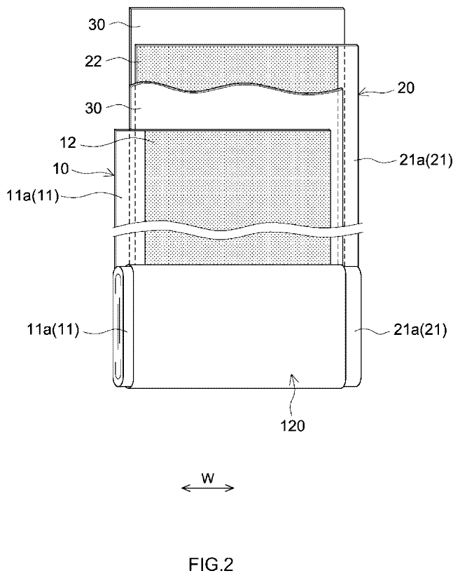

FIG. 2 is a schematic diagram illustrating a configuration of the electrode body 120. The electrode body 120 includes a laminated structure with a cathode 10 (positive electrode) and an anode 20 (negative electrode) alternately arranged via a separator 30. In this embodiment, the electrode body 120 is a flat wound electrode body, which is formed by winding an elongated sheet-like laminate (having a width perpendicular to its longitudinal direction) having the elongated sheet-like cathode 10, the elongated sheet-like separator 30, the elongated sheet-like anode 20, and an additional elongated sheet-like separator 30 arranged in this order. Instead of this configuration, the electrode body 120 may be a laminated electrode body in which a quadrate cathode (positive electrode) and a quadrate anode (negative electrode) are laminated in a state insulated from each other.

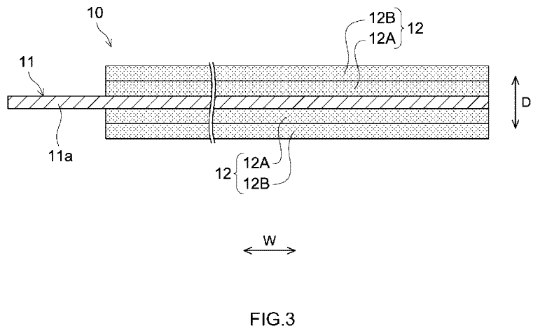

The cathode 10 has a cathode current collector 11 and cathode active material layers 12 (positive active material layers). In this embodiment, the cathode 10 has cathode active material layers 12 on both sides of the cathode current collector 11 (described later in detail with reference to FIG. 3). As illustrated in FIG. 2, the cathode current collector 11 has a portion 11a on one end (left end in FIG. 2) of the electrode body 120 or cathode 10 in a width direction W. The width direction W refers to a direction perpendicular to the longitudinal direction of the elongated sheet-like laminate. The portion 11a refers to an exposed partial area where the cathode active material layer 12 is not laminated on the cathode current collector 11. In the electrode body 120 that is a wound electrode body, the portion 11a is laminated in the laminating direction of the laminated structure of the electrode body 120 to functionally serve as a current collection portion. In this integrally laminated state, the portion 11a is connected to a cathode current collection plate 131. Examples of the constituent material for the cathode current collection plate 131 include aluminum and an aluminum alloy. Examples of the method for connecting the cathode current collection plate 131 to the portion 11a in the cathode 10 include ultrasonic joining and laser welding.

The anode 20 includes an anode current collector 21 and an anode active material layer 22 (negative active material layers). In this embodiment, the anode 20 has the anode active material layers 22 on both sides of the anode current collector 21 (not illustrated). The anode current collector 21 is preferably a strip-like conductive metal foil. Examples of a constitutive material for the anode current collector 21 include copper, a copper alloy, nickel, and stainless steel, and a copper foil is preferable. The anode active material layers 22 contain an anode active material (negative active material) capable of reversibly storing and releasing charge carriers. Examples of the anode active material include a carbon material such as graphite, hard carbon, and soft carbon. The graphite may be natural graphite or artificial graphite. The anode active material may also be a silicon-containing material. Examples of the silicon-containing material include silicon (Si), silicon oxide represented by SiOₓ (0.05<x<1.95), an Si—C composite containing Si particles in carbon particles, and lithium silicate (LiₓSi_{y}O_{z}). The anode active material layers 22 may contain additives other than the anode active material. Examples of the additives include a binder and a thickener. Examples of the binder include a rubber material such as styrene-butadiene rubber (SBR) and a fluororesin such as polyvinylidene fluoride (PVDF). Examples of the thickener include a cellulose material such as carboxymethylcellulose (CMC).

The anode current collector 21 has a portion 21a on the opposite end (right end in the figure) of the electrode body 120 or the anode 20 in the width direction W. The portion 21a is an exposed partial area of the anode current collector 21 where the anode active material layer 22 is not laminated. In the electrode body 120 that is a wound electrode body, the portion 21a is laminated in the laminating direction of the laminated structure of the electrode body 120 to functionally serve as a current collection portion. In this integrally laminated state, the portion 21a is connected to an anode current collection plate 141. Examples of a constituent material for the anode current collection plate 141 include copper and a copper alloy. Examples of a method for connecting the anode current collection plate 141 to the portion 21a of the anode 20 include ultrasonic joining and laser welding.

The separator 30 is intended to insulate between the cathode active material layer 12 and the anode active material layer 22 while retaining an ion-conductive electrolytic solution therebetween. A porous resin sheet made of a polyolefin resin is preferable as the separator 30. Examples of the polyolefin resin include polyethylene (PE) and polypropylene (PP). A heat resistance layer (HRL) containing an inorganic filler may be provided on the surface of the separator 30. Examples of a constituent material for the inorganic filler include alumina, boehmite, aluminum hydroxide, and titania.

The cathode terminal 130 is attached to the battery case 110 as illustrated in FIG. 1. For example, the battery case 110 has an opening for the terminal, which penetrates its constituent member (plate material) in the thickness direction, and the cathode terminal 130 is attached to the opening, with an insulative gasket interposed between the terminal 130 and the battery case 110. A method for attaching the cathode terminal 130 can be exemplified by caulking. Furthermore, the cathode terminal 130 is exposed to the outside and inside of the battery case 110. Inside the battery case 110, the cathode terminal 130 is connected to the cathode current collection plate 131. The cathode terminal 130 is electrically connected to the cathode 10 of the electrode body 120 via the cathode current collection plate 131. This cathode terminal 130 is preferably made of a metal, more preferably of aluminum or an aluminum alloy.

The anode terminal 140 is also attached to the battery case 110 (the attaching method is the same as described above for the cathode terminal 130). The anode terminal 140 is exposed to the outside and inside of the battery case 110. Inside the battery case 110, the anode terminal 140 is connected to the anode current collection plate 141. The anode terminal 140 is electrically connected to the anode 20 of the electrode body 120 via the anode current collection plate 141. This anode terminal 140 is preferably made of a metal, more preferably of copper or a copper alloy.

The nonaqueous electrolytic solution contains a nonaqueous solvent and an electrolyte (supporting salt). Examples of the nonaqueous solvent include ethylene carbonate (EC), propylene carbonate (PC), dimethyl carbonate (DMC), diethyl carbonate (DEC), and ethyl methyl carbonate (EMC). The nonaqueous solvent may be used alone or in combination with two or more types. The electrolyte is a lithium salt, preferably a fluorine-containing lithium salt. Examples of the fluorine-containing lithium salt include lithium hexafluorophosphate (LiPF₆), lithium tetrafluoroborate (LiBF₄), and lithium bis(fluorosulfonyl)imide (LiN(SO₂F)₂). The electrolyte may be used alone or in combination with two or more types. This nonaqueous electrolytic solution permeates the electrode body 120 in the battery case 110. Extra nonaqueous electrolytic solution not permeating the electrode body 120 may be stored in the battery case 110.

FIG. 3 is a schematic sectional view of the elongated sheet-like cathode 10 in the width direction, with some parts omitted. The cathode 10 has the cathode current collector 11 and the cathode active material layers 12 provided on both sides of the cathode current collector 11 in the thickness direction D. Each of the cathode active material layers 12 includes a first layer 12A and a second layer 12B. In each of the cathode active material layers 12, the first layer 12A is located between the cathode current collector 11 and the second layer 12B. In this embodiment, the first layer 12A is located on the cathode current collector 11, the second layer 12B is located on the first layer 12A, and the second layer 12B is the top layer of the cathode active material layer 12. In another embodiment, the cathode active material layers 12 may include other layers. Other layers may be located e.g. between the cathode current collector 11 and the first layer 12A.

The cathode current collector 11 is made of e.g. a conductive metal foil, or a resin sheet with a double-sided conductive metal layer. Examples of the conductive metal for the cathode current collector 11 include aluminum, an aluminum alloy, nickel, titanium, and stainless steel. Above all, aluminum is preferable. From the viewpoint of ensuring the strength of the cathode current collector 11 and consequently the strength of the cathode 10, the cathode current collector 11 has a thickness of preferably 5 μm or larger, more preferably 8 μm or larger. From the viewpoint of reducing the volume occupied by the cathode current collector 11 to ensure a volume energy density of the secondary battery 100, the cathode current collector 11 has a thickness of preferably 30 μm or smaller, more preferably 20 μm or smaller.

The first layer 12A of the cathode active material layers 12 contains first cathode active material particles (first CAM particles). The first CAM particles are e.g. composite oxide particles containing lithium (Li) and other metal elements (lithium composite oxide).

The lithium composite oxide is preferably a nickel (Ni)-containing lithium composite oxide, more preferably a high Ni-content lithium composite oxide having an Ni content of 70 mol % or more (relative to metal elements other than Li). This composition is preferable in terms of achieving a high energy density at low cost for the secondary battery 100. Examples of the Ni-containing lithium composite oxides constituting the first CAM particles include a lithium-nickel composite oxide, a lithium-nickel-cobalt composite oxide, a lithium-nickel-manganese composite oxide, a lithium-nickel-cobalt-manganese composite oxide, a lithium-nickel-cobalt-aluminum composite oxide, and a lithium-iron-nickel-manganese composite oxide. These oxides may be used alone or in combination with two or more types. From the viewpoint of ensuring all of a long cycle life, a good thermal stability, and a high energy density for the secondary battery 100, a lithium-nickel-cobalt-manganese composite oxide is preferable as the Ni-containing lithium composite oxide.

Preferably, the cathode active material (first cathode active material or first positive active material) constituting the first CAM particles has a composition represented by the following constitution formula (1).

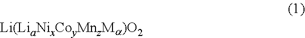

[wherein, −0.1≤a≤0.1, 0.7≤x≤1, 0≤y≤0.3, 0≤z≤0.3, x+y+z=1, 0≤α≤0.1, and M is at least one element selected from the group consisting of B, Al, Mg, Ca, Ti, V, Cr, Ga, Zr, Nb, Mo, In, Hf, Ta, W, and Tl]

In composition formula (1), a satisfies −0.1≤a≤0.1, preferably 0≤a≤0.1. From the viewpoint of achieving a high energy density at low cost for the secondary battery 100, x satisfies 0.7≤x≤1, preferably 0.75≤x≤1, more preferably 0.8≤x≤1. From the viewpoint of enhancing the structural stability of the cathode active material and reducing a resistance, y satisfies 0≤y≤0.3, preferably 0.1≤y≤0.3. From the viewpoint of enhancing the structural stability of the cathode active material and reducing the cost, z satisfies 0≤z≤0.3, preferably 0.1≤z≤0.3. The composition of the cathode active material (first cathode active material, second cathode active material described later) can be confirmed e.g. by a high-frequency inductively coupled plasma (ICP) emission spectroscopy.

Examples of a crystal structure of the Ni-containing lithium composite oxide include a layered rock salt type crystal structure and a spinel type crystal structure. Above all, a layered rock salt type crystal structure is preferable. The crystal structure can be confirmed e.g. by X-ray crystal diffraction.

Examples of the shape of the first CAM particles include an almost spherical shape, an ellipsoidal shape, and a flake-like shape. Above all, an almost spherical shape is preferable. In this specification, “almost spherical shape” means a shape that can be regarded as substantially spherical, and has an average aspect ratio (major axis/minor axis ratio) of about 1 to 2, e.g. within a range of 1 to 1.5 based on a cross-sectional observation image under an electron microscope.

From the viewpoint of ensuring the fillability of the first CAM particles in the first layer 12A, the first CAM particles have an average sphericity of preferably 0.90 or higher, more preferably 0.91 or higher, even more preferably 0.92 or higher. From the viewpoint of reducing the manufacturing cost of the secondary battery 100, the first CAM particles have an average sphericity of preferably 1.00 or lower, more preferably 0.99 or lower, even more preferably 0.98 or lower. A method for adjusting the average sphericity of the CAM particles (first CAM particles, and second CAM particles described later) can be exemplified by mechanical post-processing. As a mechanical post-processing, a method of grinding off edges and corners of the particles using a ball mill or the like is preferable. In such a treatment, the average sphericity can be improved by extending the processing time. The method for measuring the average sphericity of the CAM particles is as described later for test examples.

From the viewpoint of ensuring the particle strength, the first CAM particles have an average particle diameter D₅₀ of preferably 5 μm or larger, more preferably 7 μm or larger, even more preferably 9 μm or larger. From the viewpoint of ensuring the fillability of the first CAM particles in the first layer 12A, the first CAM particles have an average particle diameter D₅₀ of preferably 18 μm or smaller, more preferably 15 μm or smaller, even more preferably 12 μm or smaller. The average particle diameter D₅₀ of the CAM particles (first CAM particles, and second CAM particles described later) refers to a median diameter in the volume-based particle size distribution (particle diameter, at which the volume cumulative frequency accumulated from the smallest diameter side reaches 50%), and is determined e.g. based on a particle size distribution obtained by a laser diffraction/scattering method. As a method for adjusting the average particle diameter D₅₀ of the CAM particles, for example, reaction conditions are adjusted using a crystallization method described later for obtaining a composite hydroxide as a cathode active material precursor. Examples of the conditions include temperature, pH, stirring speed, various concentrations such as ammonium ion concentration, and reaction time, for the reaction liquid.

The first CAM particles may be primary particles or secondary particles formed through aggregation of the multiple primary particles by physical or chemical bonding forces, preferably secondary particles having voids between the aggregated primary particles thereinside.

The first CAM particles have an average particle strength of preferably 110 MPa or higher, more preferably 125 MPa or higher, even more preferably 140 MPa or higher.

This configuration is preferable for suppressing press cracking of the first CAM particles in the first layer 12A during the pressing step described later in the manufacturing process of the secondary battery 100. The first CAM particles have an average particle strength of preferably 160 MPa or lower, more preferably 155 MPa or lower, even more preferably 150 MPa or lower. This configuration is preferable for ensuring flexibility of the first CAM particles in the first layer 12A and improving the fillability during the pressing step described later in the manufacturing process of the secondary battery 100. The average particle strength of the first CAM particles can be determined as an average value of a crushing strength of the first CAM particles. The crushing strength of particles such as the first CAM particles can be measured e.g. using an ultra-micro indentation hardness tester (product name “ENT-5”, manufactured by ELIONIX INC.). A method for deriving an average particle strength of the CAM particles (first CAM particles, second CAM particles described later) is as described later for test examples. As a method for adjusting the average particle strength of the CAM particles, for example, the reaction conditions are adjusted using a crystallization method described later for obtaining a composite hydroxide as the cathode active material precursor. The conditions include e.g. temperature, pH, stirring speed, various concentrations such as ammonium ion concentration, and reaction time, for the reaction liquid. Examples of the method for adjusting the average particle strength of the CAM particles also include a method for adjusting a calcination temperature of the CAM particles, and a method for selecting the type of a coating element described later and adjusting the amount of the coating element for the CAM particles.

The first CAM particles may have a surface layer portion enriched with at least one element selected from the group consisting of Group 6 elements and Group 13 elements, similarly to the second CAM particles described later. The enriched surface layer portion refers to a region within 20% range from the particle outermost surface, in an area extending from the particle outermost surface to the particle center, where the concentration of the element (coating element) is higher than at the particle center.

The particle center may or may not contain the element (coating element). Examples of Group 6 elements include Cr, Mo, and W, and examples of Group 13 elements include B, Al, Ga, In, and Tl. The ratio of the coating element to the total amount of Ni, Co, and Mn (Ni+Co+Mn) in the first CAM particle is preferably lower than 0.8 mol %, preferably 0.7 mol % or lower, more preferably 0.6 mol % or lower. The CAM particles (first CAM particles, second CAM particles described later) have a tendency that the higher the ratio of the coating element to the total amount of the metal elements (Ni+Co+Mn), the higher the coating element concentration in the surface layer. For particles containing the coating elements in the CAM particles (first CAM particles, second CAM particles described later), the presence of the coating elements in the surface layer portion can be confirmed e.g. by LA-ICP-MS (Laser Ablation Inductively Coupled Plasma Mass Spectrometry).

The first layer 12A may contain additives other than the first CAM particles.

Examples of the additives include another cathode active material particle, a conductive material, a binder, and trilithium phosphate. Examples of the conductive material include acetylene black, Ketjen black, graphite, and carbon nanotube. Examples of the binder include a fluororesin such as polyvinylidene fluoride (PVDF) and a rubber material such as styrene-butadiene rubber (SBR).

The second layer 12B of the cathode active material layers 12 contains second cathode active material particles (second CAM particles). The second CAM particles are e.g. lithium composite oxide particles. The lithium composite oxide constituting the second CAM particles is preferably an Ni-containing lithium composite oxide, more preferably a high Ni-content lithium composite oxide having an Ni content of 70 mol % or more (ratio relative to metal elements other than Li). This composition is preferable for achieving a high energy density at low cost for the secondary battery 100.

Examples of the Ni-containing lithium composite oxide constituting the second CAM particles include the Ni-containing lithium composite oxide described above for the first CAM particles, and a lithium-nickel-cobalt-manganese composite oxide is preferable.

Preferably, the cathode active material (second cathode active material or second positive active material) constituting the second CAM particles has the composition represented by the above constitution formula (1). In the second CAM particles, the preferable ratio of the elements in the composition formula (1) is the same as described above for the first CAM particles. The crystal structure, particle shape, and particle aggregation state (primary particles, secondary particles) of the second cathode active material constituting the second CAM particles are the same as those described above for the first cathode active material constituting the first CAM particles.

The second CAM particles have an average sphericity of 0.95 or higher, preferably 0.96 or higher, more preferably 0.97 or higher. This configuration helps to ensure the slipperiness between the second CAM particles in the second layer 12B during the pressing step described later in the secondary battery 100 manufacturing process, consequently to relieve the press load acting on the second CAM particles. The average sphericity of the second CAM particles is 1.0 or lower, and, from the viewpoint of reducing the manufacturing cost of the secondary battery 100, it is preferably 0.99 or lower, more preferably 0.98 or lower.

From the viewpoint of ensuring the particle strength, the second CAM particles have an average particle diameter D₅₀ of preferably 3 μm or larger, more preferably 4 μm or larger, even more preferably 5 μm or larger. From the viewpoint of ensuring the fillability of the second CAM particles in the second layer, the second CAM particles have an average particle diameter D₅₀ of preferably 15 μm or smaller, more preferably 12 μm or smaller, even more preferably 10 μm or smaller.

The average particle strength of the second CAM particles is higher than that of the first CAM particles described above. The second CAM particles have an average particle strength of preferably 190 MPa or higher, more preferably 200 MPa or higher, even more preferably 210 MPa or higher. These configurations help to suppress the press cracking of the cathode active material particles in the second layer 12B (closer to the press roll than the first layer 12A) on which the press load is more likely to be focused than the first layer 12A. The second CAM particles have an average particle strength of e.g. 300 MPa or lower, 280 MPa or lower, or 250 MPa or lower.

The second CAM particles have a surface layer portion enriched with at least one element (coating element) selected from the group consisting of Group 6 elements and Group 13 elements. The coating element concentration in the surface layer portion of the second CAM particles is higher than that in the surface layer portion of the first CAM particles described above. The coating element is more preferably at least one element selected from the group consisting of W, Mo, Cr, B, Al, Ga, In, and Tl, even more preferably W. The ratio of the coating element to the total amount of Ni, Co, and Mn (Ni+Co+Mn) in the second CAM particles is preferably 0.8 mol % or higher, more preferably 1.5 mol % or higher, even more preferably 1.9 mol % or higher, particularly preferably 2.2 mol % or higher. The above configurations of the surface layer portion of the second CAM particles are suitable for achieving a high average particle strength for the second CAM particles. From the viewpoint of ensuring the energy density of the secondary battery 100, the ratio of the coating element to the total amount of the metal elements (Ni+Co+Mn) in the second CAM particles is preferably 3.0 mol % or lower, preferably 2.7 mol % or lower, more preferably 2.5 mol % or lower.

The second layer 12B may contain additives other than the second CAM particles. Examples of the additives include another cathode active material particle, a conductive material, a binder, and trilithium phosphate, similarly to those described above for the first CAM particles.

In this embodiment, the total thickness of the cathode active material layers 12 is the sum of the thickness of the first layer 12A and the thickness of the second layer 12B. From the viewpoint of ensuring the minimum handleability required for the electrode plate, the cathode active material layers 12 have a total thickness of preferably m or larger, more preferably 40 μm or larger. From the viewpoint of ensuring a good rate characteristics for the secondary battery 100, the cathode active material layers 12 have a total thickness of preferably 100 μm or smaller, more preferably 90 μm or smaller, even more preferably 80 μm or smaller. The first layer 12A has a thickness of e.g. 15 μm or larger, preferably 20 μm or larger, and, e.g. 90 μm or smaller, preferably 80 μm or smaller. The second layer 12B has a thickness of e.g. 3 μm or larger, preferably 5 μm or larger, and, e.g. 50 μm or smaller, preferably 40 μm or smaller.

From the viewpoint of suppressing particle cracking on the second layer 12B on which a stress is focused during pressing of the cathode 10, a ratio of the thickness of the second layer 12B to the total thickness of the cathode active material layers 12 is preferably 5% or higher, more preferably 8% or higher, even more preferably 10% or higher. From the viewpoint of ensuring an energy density in the cathode 10, the ratio of the thickness of the second layer 12B to the total thickness of the cathode active material layers 12 is preferably 65% or lower, more preferably 45% or lower, even more preferably 25% or lower.

For example, the aforementioned cathode active material particles (first and second CAM particles) can be prepared as follows.

First, a composite hydroxide that is a precursor of the cathode active material (lithium composite oxide) is obtained by a crystallization method. In the crystallization method, for example, a raw material aqueous solution containing predetermined metal salts is added dropwise to a pH-adjusted reaction liquid while stirring the reaction liquid (crystallization reaction). The reaction liquid is e.g. ion-exchanged water at pH 7. The raw material aqueous solution contains metal salts at predetermined concentrations, which serve as sources for each metal element (excluding the aforementioned lithium and coating elements) contained in the cathode active material to be prepared. As the metal salts, for example, a nickel salt, a cobalt salt, and a manganese salt are used depending on the composition of the cathode active material to be prepared. Examples of the nickel salt may include nickel sulfate, nickel nitrate, and nickel carbonate. Examples of the cobalt salt may include cobalt sulfate, cobalt nitrate, and cobalt carbonate. Examples of the manganese salt may include manganese sulfate, manganese nitrate, and manganese carbonate. For the reaction liquid during the crystallization reaction, the temperature is maintained e.g. at 25° C., the pH is maintained e.g. at 10 to 13 by adding an alkaline aqueous solution (e.g. sodium hydroxide aqueous solution), the ammonium ion concentration is controlled at 10 to 15 g/L by adding a basic aqueous solution containing ammonium ions (e.g. ammonia water). By this crystallization reaction, the composite hydroxide that is a precursor of the cathode active material is precipitated (coprecipitated). The obtained coprecipitate (hydroxide particles) is filtered, washed with water, and dried to obtain a powder of the composite hydroxide that is the precursor of the cathode active material.

Subsequently, the obtained composite hydroxide powder and lithium hydroxide (LiOH) powder are dry-mixed in a predetermined mass ratio to prepare a mixed powder (preparation of the first mixed powder). Then, this mixed powder is calcined e.g. under ambient atmosphere. The calcination temperature is set to e.g. 650° C. to 900° C., and the calcination time is set to e.g. 9 to 15 hours. Thereby, a lithium composite oxide powder having a predetermined composition can be obtained.

In a case of adding the aforementioned coating element to the cathode active material particles, the obtained lithium composite oxide powder and the coating element oxide powder are then dry-mixed in a predetermined ratio to prepare a mixed powder (preparation of the second mixed powder). As the coating element oxide, for example, tungsten oxide (e.g. WO₃), boric acid, and aluminum oxide may be used depending on the type of the coating element to be added. Subsequently, this mixed powder is calcined e.g. under ambient atmosphere. The calcination temperature is set to e.g. 300° C., and the calcination time is set to e.g. 1 to 3 hours. Thereby, cathode active material particles with surfaces enriched with the aforementioned coating element can be obtained.

In a case of adjusting the sphericity of the cathode active material particles, the obtained cathode active material particles are milled using a ball milling device. For the ball milling, the rotation speed is set to e.g. 100 to 200 rpm, the processing time is set to e.g. 1 to 2 hours, and the ball diameter (φ) is set to e.g. 2 to 5 mm.

The first cathode active material particles for forming the first layer 12A and the second cathode active material particles for forming the second layer 12B in the cathode 10 can be prepared e.g. by the aforementioned methods. For preparing the cathode 10 of the secondary battery 100, a first cathode slurry containing the first cathode active material particles and a second cathode slurry containing the second cathode active material particles are each prepared. Examples of the solvent for preparing the slurry include N-methyl-2-pyrrolidone (NMP), dimethylsulfoxide (DMSO), and isopropyl alcohol. The first cathode slurry and the second cathode slurry each contain the aforementioned additives (conductive material, binder, etc.) other than the cathode active material particles as necessary. Subsequently, one side of the aforementioned cathode current collector 11 is coated with the first cathode slurry and dried, and then coated with the second cathode slurry and dried to form a cathode active material layer. Then, the other side of the cathode current collector 11 is coated with the first cathode slurry and dried, and then coated with the second cathode slurry and dried to form a cathode active material layer. Subsequently, the cathode active material layers on both sides of the cathode current collector 11 are compressed in the thickness direction e.g. by pressing it between a pair of press rolls, to form consolidated (high capacity density) cathode active material layers 12 on both sides of the cathode current collector 11 (pressing step). As described above, the cathode 10 can be prepared. The secondary battery 100 can be produced so as to include the electrode body 120 equipped with this cathode 10 as the cathode responsible for the battery reaction during charging and discharging.

The secondary battery 100 is suitable for reducing gas generation amount in the cathode 10 while ensuring the energy density. The reason for this is as follows.

In the cathode active material layers 12 (including the first layer 12A and the second layer 12B in this order from the cathode current collector 11 side) of the secondary battery 100, the second CAM particles in the second layer 12B have an average particle strength higher than that of the first CAM particles in the first layer 12A, as described above. This helps to suppress press cracking of the second CAM particles in the second layer 12B (closer to the press roll than the first layer 12A), where the load from the press roll (press load) is more likely to concentrate than in the first layer 12A, in the pressing step aforementioned for the manufacturing process of the secondary battery 100. When the press cracking on the second CAM particles is suppressed, formation of new exposed surfaces (newly generated surfaces) on the second CAM particles is suppressed, and gas generation resulting from contact between the newly generated surfaces and the nonaqueous electrolytic solution, or the like is suppressed.

Furthermore, as described above, the second CAM particles in the second layer 12B have an average sphericity of 0.95 or higher. This helps to ensure the slipperiness between the second CAM particles in the second layer 12B and consequently to relieve the press load acting on the second CAM particles. The relief of the press load on the second CAM particles helps to suppress the press cracking of the particles to reduce the aforementioned gas generation.

Furthermore, the first layer 12A of the cathode active material layers 12 contains the first CAM particles, which are flexible because of their lower average particle strength than that of the second CAM particles in the second layer 12B. This helps to relieve the press load on the second layer 12B in the aforementioned pressing step, because the first layer 12A functionally serves as a cushion between the cathode current collector 11 and the second layer 12B. The relief of the press load on the second layer 12B helps to suppress the press cracking of the second CAM particles in the second layer 12B to reduce the aforementioned gas generation.

Furthermore, the first CAM particles, which are flexible because of their lower average particle strength compared to the second CAM particles, are more easily deformed by the press load and have higher fillability (more easily densified) than the second CAM particles. The cathode active material layers 12 including the first layer 12A containing the first CAM particles are suitable for ensuring a high capacity density in the cathode active material layers 12 or the cathode 10, and therefore suitable for ensuring a high energy density in the secondary battery 100.

As described above, the secondary battery 100 having the above configuration is suitable for reducing the gas generation in the cathode 10 while ensuring the energy density.

In the above embodiment, the secondary battery 100 has been explained as a rectangular secondary battery including a flat electrode body 120. However, the secondary battery disclosed herein may also be a secondary battery having another shape or form. For example, the technology disclosed herein can also be applied to a lithium ion secondary battery with a laminated electrode body, a cylindrical lithium ion secondary battery, a laminated lithium ion secondary battery, and the like.

### TEST EXAMPLES

Test examples according to the present invention will be explained below, however, the present invention is not intended to be limited to the test examples.

### Example 1

### [Preparation of Cathode]

A cathode of Example 1 was prepared by performing preparation of the first cathode active material, preparation of the second cathode active material, and formation of the cathode active material layer, as described below.

### <Preparation of First Cathode Active Material>

For the preparation of the first cathode active material (first CAM), first, a nickel-cobalt-manganese (NCM) composite hydroxide as a precursor of the first CAM was obtained. Specifically, a raw material aqueous solution and a reaction liquid were first prepared. The reaction liquid was prepared in a 5 L reaction vessel. The raw material aqueous solution contained nickel sulfate, cobalt sulfate, and manganese sulfate in a molar ratio of Ni:Co:Mn=80:10:10 so that the total concentration of these metal salts was 1.5 mol/L. The reaction liquid was ion-exchanged water, which had undergone removal of dissolved oxygen via inert gas purging, and pH adjustment to 10.5 to 11.5 (at 25° C.) via addition of sodium hydroxide aqueous solution (while maintaining the liquid temperature at 30° C.). Subsequently, the raw material aqueous solution was added dropwise to the reaction liquid while stirring the reaction liquid (stirring speed: 600 rpm), and the mixture was subjected to a crystallization reaction to precipitate (coprecipitate) the NCM composite hydroxide. During the dripping, the reaction liquid was maintained at 25° C. to 35° C. and at pH 10.5 to 11.5 by adding sodium hydroxide aqueous solution, and the ammonium ion concentration was controlled to 10 g/L by adding ammonia water (crystallization was performed for 20 hours under these conditions). Then, the obtained coprecipitate (hydroxide particles) was filtered and washed with water, and then dried in an oven at 120° C. to obtain a powder. Thereby, a powder of NCM composite hydroxide (Ni_{0.8}Co_{0.1}Mn_{0.1}(OH)₂) was obtained as the first CAM precursor.

Subsequently, the obtained NCM composite hydroxide powder and a lithium hydroxide (LiOH) powder were mixed in a molar ratio of Li:(Ni+Co+Mn)=1.05:1.00 to prepare a mixed powder (preparation of the first mixed powder). This mixed powder was then calcined under ambient atmosphere at 770° C. for 15 hours (first calcination treatment) to obtain a lithium composite oxide powder.

Subsequently, the obtained lithium composite oxide powder and a tungsten oxide (WO₃) powder were mixed in a composition of (Ni+Co+Mn):W=1.000:0.005 to prepare a mixed powder (preparation of the second mixed powder). Then, this mixed powder was calcined under ambient atmosphere at 300° C. for 3 hours (second calcination treatment) to obtain a first CAM powder. The particles in this powder were the first CAM particles with surfaces enriched with tungsten (Li(Li_{0.05}Ni_{0.8}Co_{0.1}Mn_{0.1}W_{0.005})O₂, W ratio: 0.5 mol %, average particle diameter D₅₀: 10 μm).

### <Preparation of Second Cathode Active Material>

For the preparation of the second cathode active material (second CAM), first, a nickel-cobalt-manganese (NCM) composite hydroxide as a precursor of the second CAM was obtained. Specifically, a raw material aqueous solution and a reaction liquid were first prepared. The reaction liquid was prepared in a 5 L reaction vessel. The raw material aqueous solution contained nickel sulfate, cobalt sulfate, and manganese sulfate in a molar ratio of Ni:Co:Mn=80:10:10 so that the total concentration of these metal salts was 1.5 mol/L. The reaction liquid was ion-exchanged water, which had undergone removal of dissolved oxygen via inert gas purging, and pH adjustment to 12.0 to 12.5 (at 25° C.) via addition of sodium hydroxide aqueous solution (while maintaining the liquid temperature at 30° C.). Subsequently, in the first step of crystallization, the raw material aqueous solution was added dropwise to the reaction liquid while stirring the reaction liquid (stirring speed: 500 rpm), and the mixture was subjected to a crystallization reaction to precipitate (coprecipitate) the NCM composite hydroxide. During the dripping, the reaction liquid was maintained at 25° C. to 35° C. and at pH 12.0 to 12.5 by adding sodium hydroxide aqueous solution, the ammonium ion concentration was controlled to 10 g/L by adding ammonia water, and the crystallization time was set to 1 hour. Subsequently, in the second step of crystallization, the pH of the reaction liquid was adjusted to 10.5 to 11.5 by dripping sulfuric acid, and then the NCM composite hydroxide was precipitated (coprecipitated) over a period of 20 hours, where the other conditions were the same as in the first step. Then, the obtained coprecipitate (hydroxide particles) was filtered and washed with water, and then dried in an oven at 120° C. to obtain a powder. In this process, a powder of NCM composite hydroxide (Ni_{0.8}Co_{0.1}Mn_{0.1}(OH)₂) was obtained as the second CAM precursor.

Subsequently, the obtained NCM composite hydroxide powder and a lithium hydroxide (LiOH) powder were mixed in a molar ratio of Li:(Ni+Co+Mn)=1.05:1.00 to prepare a mixed powder (preparation of the first mixed powder). This mixed powder was calcined under ambient atmosphere at 780° C. for 4 hours, and then at 900° C. for 5 hours (first calcination treatment) to obtain a lithium composite oxide powder.

Subsequently, the obtained lithium composite oxide powder and a tungsten oxide (WO₃) powder were dry-mixed in a composition of (Ni+Co+Mn):W=1.000:0.010 using an auto-mortar to prepare a mixed powder (preparation of the second mixed powder). Then, this mixed powder was calcined under ambient atmosphere at 300° C. for 3 hours (second calcination treatment) to obtain a second CAM powder. The particles in this powder were the second CAM particles with surfaces enriched with tungsten (Li(Li_{0.05}Ni_{0.8}Co_{0.1}Mn_{0.1}W_{0.010})O₂, W ratio: 1.0 mol %, average particle diameter D₅₀: 4.0 μm).

Subsequently, ball milling was performed. Specifically, the second CAM was ball-milled using a ball milling apparatus (product name “Planetary Ball Mill PULNERISETTE 5”, manufactured by Fritsch GmbH) and a zirconia ball (manufactured by Nikkato Corporation, average diameter: 2 mm) as a milling medium at 100 rpm for 1 hour. In this ball milling, the volume ratio of balls and the sample and excess space was adjusted to approximately 1:1:1, and the apparatus was stopped every 15 minutes to stir the sample and balls. Thereby, a powder of the second CAM with a high sphericity. The particles in this powder were the second CAM particles (Li(Li_{0.05}Ni_{0.8}Co_{0.1}Mn_{0.1}W_{0.01})O₂, W ratio: 1.0 mol %, average particle diameter D₅₀: 4.0 μm) with surfaces enriched with tungsten.

### <Formation of Cathode Active Material Layer>

First, a cathode current collector, as well as a first cathode slurry and a second cathode slurry for forming the first layer and the second layer of the cathode active material layer (CAM layer) on the cathode current collector were prepared. The cathode current collector was an aluminum foil having a thickness of 13 μm. The first cathode slurry was obtained by kneading a mixture containing the aforementioned first CAM, carbon black (CB) as a conductive material, and polyvinylidene fluoride (PVDF) as a binder in a mass ratio of first CAM:CB:PVDF=100:1.5:1 and additionally containing a predetermined amount of N-methyl-2-pyrrolidone (NMP) as a solvent.

The second cathode slurry is obtained by kneading a mixture containing the aforementioned second CAM, CB, and PVDF in a mass ratio of second CAM:CB:PVDF=100:1.5:1 and additionally containing a predetermined amount of NMP. Subsequently, one side of the cathode current collector was coated with the first cathode slurry and dried, and then coated with the second cathode slurry and dried to form CAM layers (first layer, second layer). Then, the other side of the cathode current collector was coated with the first cathode slurry and dried, and then coated with the second cathode slurry and dried to form CAM layers (first layer, second layer). Subsequently, the cathode current collector having the CAM layer was rolled using a roller so that the CAM layer had a thickness of 70 μm and was at a density of 3.6 g/cm³ (CAM layer rolling step). Thereby a cathode having a cathode current collector with both sides that each have a bilayer CAM layer is obtained. A ratio of the second layer thickness in each CAM layer was set to 10% (first layer:second layer=9:1 [thickness ratio]; a ratio of the second layer thickness to the first layer thickness was 0.11).

As described above, the cathode (positive electrode) of Example 1 was prepared. The cathode of Example 1 has a laminated structure of CAM layer (second layer/first layer)/cathode current collector (aluminum foil)/CAM layer (first layer/second layer).

### [Preparation of Anode]

First, an anode current collector and an anode slurry for forming an anode active material layer (AAM layer) on the anode current collector were prepared. The anode current collector is a copper foil having a thickness of 8 μm. The anode slurry was obtained by kneading graphite as the anode active material (AAM), styrene-butadiene rubber (SBR) as the binder, and carboxymethylcellulose (CMC) as the thickener in a mass ratio of AAM:SBR:CMC=100:0.7:1, in an ion-exchanged water. Subsequently, both sides of the anode current collector were coated with the anode slurry to form a coating film, then the coating film was dried to form an AAM layer. The anode current collector having the AAM layer was rolled to a predetermined thickness using a roller. As described above, the anode (negative electrode) of Example 1 was prepared.

### [Preparation of Secondary Battery]

First, the aforementioned cathode and anode were cut out into a cathode sheet (CAM layer/cathode current collector/CAM layer) and an anode sheet (AAM layer/anode current collector/AAM layer). A separator having a double-layer structure of polyethylene/heat-resistant layer was also prepared. Subsequently, these layers were laminated such that the heat-resistant layer of the separator was brought into contact with the CAM layer of the cathode sheet and the cathode current collector was exposed, to obtain a laminated electrode body (electrode assembly). Next, the cathode current collector (aluminum foil) of the cathode sheet in this laminated electrode body was welded to a cathode lead (aluminum plate) for external current collection, and the anode current collector (copper foil) of the anode sheet was welded to an anode lead (copper plate) for external current collection. Then, the electrode body of the laminated electrode body with the lead was inserted into an exterior casing (a pouch made of laminated aluminum film), and a nonaqueous electrolytic solution was injected into the exterior casing, which was left to stand for 12 hours, and then the exterior casing was sealed. The nonaqueous electrolyte contained a mixed solvent of ethylene carbonate (EC), ethyl methyl carbonate (EMC), and dimethyl carbonate (EC:EMC:DMC=30:30:40 [volume ratio]), and LiPF₆ (concentration: 1.15 mol/L) as the electrolyte, which is dissolved in this mixed solvent. Thereby, the secondary battery (lithium ion battery) of Example 1 for evaluation was obtained. In this secondary battery, the laminated electrode body and the nonaqueous electrolytic solution are enclosed in an exterior casing (pouch), and a part on each distal end side of the cathode lead and anode lead in the laminated electrode body is exposed to the outside of the exterior casing.

### Example 2

The secondary battery of Example 2 was prepared in the same manner as for the secondary battery of Example 1 except that the following process was performed. In preparing the second mixed powder for the second layer of the CAM layer, the W ratio in the second mixed powder was set to 2.0 mol %. The particles in the obtained second CAM powder were second CAM particles (Li(Li_{0.05}Ni_{0.8}Co_{0.1}Mn_{0.1}W_{0.02})O₂, W ratio: 2.0 mol %, average particle diameter D₅₀: 5.0 μm) with surfaces enriched with tungsten.

### Example 3

The secondary battery of Example 3 was prepared in the same manner as for the secondary battery of Example 1 except for the method for preparing the second cathode active material for the second layer of the CAM layer. The method for preparing the second cathode active material in Example 3 is the same as the method for preparing the first cathode active material in Example 1 except that the following process was performed (ball milling was not performed).

In the CAM precursor obtaining step, the stirring speed for the reaction liquid during the crystallization reaction was set to 500 rpm. In the first calcination treatment, the calcination temperature was set to 800° C., and the calcination time was set to 15 hours. The W ratio in the mixed powder was set to 2.5 mol %. The particles in the obtained second CAM powder were second CAM particles (Li(Li_{0.05}Ni_{0.8}Co_{0.1}Mn_{0.1}W_{0.025})O₂, W concentration: 2.5 mol %, average particle diameter D₅₀: 12 μm) with surfaces enriched with tungsten.

### Example 4

The secondary battery of Example 4 was prepared in the same manner as for the secondary battery of Example 1 except that, in preparing the first CAM for the first layer, the preparation of the second mixed powder and the subsequent calcination were not performed.

### Example 5

The secondary battery of Example 5 was prepared in the same manner as for the secondary battery of Example 1 except that the thickness ratio of the second layer in each CAM layer (thickness: 70 μm) was set to 50% in forming the CAM layer.

### Example 6

The secondary battery of Example 6 was prepared in the same manner as for the secondary battery of Example 1 except that the following process was performed. In preparing the first mixed powder for the first layer of the CAM layer, the W ratio in the first mixed powder was set to 0.7 mol %. The particles in the obtained first CAM powder were first CAM particles (Li(Li_{0.05}Ni_{0.8}Co_{0.1}Mn_{0.1}W_{0.007})O₂, W concentration: 0.7 mol %, average particle diameter D₅₀: 10 μm) with surfaces enriched with tungsten.

### Example 7

The secondary battery of Example 7 was prepared in the same manner as for the secondary battery of Example 1 except that the thickness ratio of the second layer in each CAM layer (thickness: 70 μm) was set to 60% in forming the CAM layer.

### Example 8

The secondary battery of Example 8 was prepared in the same manner as for the secondary battery of Example 1 except that, in forming the CAM layer, CAM layers with a thickness of 70 μm were formed from the first cathode slurry (containing the first CAM) on both sides of the cathode current collector without using the second cathode slurry.

### Example 9

The secondary battery of Example 9 was prepared in the same manner as for the secondary battery of Example 1 except that, in forming the CAM layer, CAM layers with a thickness of 70 μm were formed from the second cathode slurry (containing the second CAM) on both sides of the cathode current collector without using the first cathode slurry.

### Example 10

The secondary battery of Example 10 was prepared in the same manner as for the secondary battery of Example 1 except that, in preparing the second CAM for the second layer, the preparation of the second mixed powder and the subsequent calcination were not performed.

### Example 11

The secondary battery of Example 11 was prepared in the same manner as for the secondary battery of Example 1 except that the following process was performed.

In preparing the second mixed powder for the second layer of the CAM layer, the W ratio in the second mixed powder was set to 0.5 mol %. The particles in the obtained second CAM powder were second CAM particles (Li(Li_{0.05}Ni_{0.8}Co_{0.1}Mn_{0.1}W_{0.005})O₂, W concentration: 0.5 mol %, average particle diameter D₅₀: 4.0 μm) with surfaces enriched with tungsten.

### Example 12

The secondary battery of Example 12 was prepared in the same manner as for the secondary battery of Example 1 except that the second CAM for the second layer of the CAM layer was not subjected to ball milling.

### <Compositional Analysis for Cathode Active Material>

The composition of each cathode active material (CAM) in Examples 1 to 12 was confirmed using an ICP emission spectrometer (product name: “SPS3520UV-DD”, manufactured by Hitachi High-Tech Science Corporation).

### <Particle Diameter>

Each average particle diameter D₅₀ of the first CAM particles and second CAM particles in Examples 1 to 12 was measured using a laser diffraction particle size distribution analyzer (product name: “MT3000II”, manufactured by MicrotracBEL Corp.). The results are presented in Table 1.

### <Average Particle Strength>

Each average particle strength of the first CAM particles and second CAM particles in Examples 1 to 12 was investigated as follows.

Particle strengths were measured using an ultra-micro indentation hardness tester ENT-5 manufactured by ELIONIX INC. Specifically, first, the CAM particle powder as a sample was fixed on a stage provided on the tester. Subsequently, ten particles were arbitrarily selected from the sample using an optical microscope provided on the tester, and position coordinates of each particle on the stage were stored. A diameter (d) of each particle was measured from an image captured by a tester's camera. Then, the stage was moved to directly under the flat indenter, pointing downward, set on the tester. Based on the position coordinate data of one predetermined particle (target particle), the stage was finely adjusted so that the flat indenter was positioned directly above the particle. Then, the flat indenter was lowered to the target particle on the stage, and a pressing strength required for crushing the particle was measured by the tester. In this measurement, the deformation of the particle was automatically measured while gradually increasing a test load (pressing load or pressing strength) on the particle at a constant rate. In this measurement, a test load P (MPa) at which the particle was crushed (rapid deformation) was measured. Then, a crushing strength St (MPa) was calculated from the test load P and the particle diameter d (μm) in accordance with the following equation (2) in JIS Z 8844 (2019). An average value of the crushing strengths St obtained for 10 particles was calculated as an average particle strength (MPa). The average values are presented in Table 1.

St=2.8P/πd² (2)

### <Average Sphericity>

Each average sphericity of the first CAM particles and second CAM particles in Examples 1 to 12 was investigated as follows.

First, each sphericity of the CAM particles (powder) to be measured was analyzed using a particle image analyzer Morphologi 4 (manufactured by Malvern Panalytical). Specifically, each sphericity (4πS/L²: S is a particle area, L is a circumference of the particle image) of 50 particles arbitrarily selected from the powder was measured, and then an average sphericity of the 50 particles was calculated. This value was defined as an average sphericity. The average values are presented in Table 1.

### <Coating Element Content>

Among the CAM particles (first CAM Particle, second CAM Particle) in Examples 1 to 12, for particles containing tungsten (W), the presence of W as a surface layer element was confirmed by an LA-ICP-MS analysis. Regarding the CAM particles prepared as described above, the higher the ratio of W (coating element) relative to the constituent metal elements (Ni, Co, Mn), the higher the ratio of W (coating element) in the surface layer. For the W-containing CAM particles, W ratios relative to the total amount of constituent metal elements (Ni+Co+Mn) are presented in Table 1 as the coating element amounts (mol %).

### <Energy Density>

An energy density of each secondary battery in Examples 1 to 12 was investigated as follows.

First, at 25° C., the secondary battery was subjected to constant current charging at a constant current density (0.2 mA/cm²) until the voltage reached 4.18 V, followed by constant voltage charging at a constant voltage (4.18 V) until the current density reached 0.04 mA/cm². Subsequently, at 25° C., the secondary battery was subjected to constant current discharging at a constant current density (0.2 mA/cm²) until the voltage reached 3.48 V to measure a discharge capacity (discharge energy). An energy density (Wh/L) of the secondary battery was calculated by dividing the discharge capacity (Wh) by the volume (L) of the secondary battery. Table 1 presents each relative energy density value of each secondary battery relative to the energy density: 100 of the secondary battery in Example 8.

### <Gas Generation Amount in Storage Test>

Each secondary battery in Examples 1 to 12 was subjected to a storage test as follows to investigate a gas generation amount.

First, the volume (initial volume) of the secondary battery was measured using Archimedes method. Fluorinert was used as a liquid for Archimedes method. Subsequently, at 25° C., the secondary battery was subjected to constant current charging at a constant current density (0.2 mA/cm²) until the voltage reached 4.2 V, followed by constant voltage charging at a constant voltage (4.2 V) until the current density reached 0.04 mA/cm². Then, the charged secondary battery was stored in a thermostat at 60° C. for 5 days. Subsequently, the secondary battery was allowed to cool at 25° C. The volume (post-storage test volume) of the cooled secondary battery was measured under the same conditions as in the initial volume measurement using Archimedes method. A difference (mL) between the post-storage test volume and the initial volume was calculated and defined as a gas generation amount. Table 1 presents each relative gas generation amount value of each secondary battery relative to the gas generation amount: 100 of the secondary battery in Example 8.

TABLE 1

| | | | | | | | | | | | Gas |
|---|---|---|---|---|---|---|---|---|---|---|---|
| | Average particle | | Average particle | | | | Coating element amount | | Thickness | Energy | generation |
| | diameter D₅₀ (μm) | | strength (MPa) | | Average sphericity | | (mol %) | | ratio of | density | amount |
| | First | Second | First | Second | First | Second | First | Second | second | (relative | (relative |
| | layer | layer | layer | layer | layer | layer | layer | layer | layer (%) | value) | value) |
| Example 1 | 10 | 4.0 | 143 | 197 | 0.96 | 0.96 | 0.5 | 1.0 | 10 | 103 | 77 |
| Example 2 | 10 | 5.0 | 143 | 212 | 0.96 | 0.96 | 0.5 | 2.0 | 10 | 103 | 70 |
| Example 3 | 10 | 12 | 143 | 205 | 0.96 | 0.98 | 0.5 | 2.5 | 10 | 102 | 80 |
| Example 4 | 10 | 4.0 | 118 | 197 | 0.96 | 0.96 | 0.0 | 1.0 | 10 | 103 | 85 |
| Example 5 | 10 | 4.0 | 143 | 197 | 0.96 | 0.96 | 0.5 | 1.0 | 50 | 101 | 75 |
| Example 6 | 10 | 4.0 | 156 | 197 | 0.96 | 0.96 | 0.7 | 1.0 | 10 | 100 | 77 |
| Example 7 | 10 | 4.0 | 143 | 197 | 0.96 | 0.96 | 0.5 | 1.0 | 60 | 98 | 75 |
| Example 8 | 10 | — | 143 | — | 0.96 | — | 0.5 | — | — | 100 | 100 |
| Example 9 | 4 | — | 197 | — | 0.96 | — | 1.0 | — | — | 90 | 72 |
| Example 10 | 10 | 4.0 | 143 | 165 | 0.96 | 0.95 | 0.5 | 0.0 | 10 | 102 | 96 |
| Example 11 | 10 | 4.0 | 143 | 182 | 0.96 | 0.96 | 0.5 | 0.5 | 10 | 102 | 90 |
| Example 12 | 10 | 4.0 | 143 | 197 | 0.96 | 0.91 | 0.5 | 1.0 | 10 | 100 | 90 |

As presented in Table 1, among the secondary batteries of Examples 1 to 12, the secondary battery of Example 8 exhibited the highest gas generation amount. This may be because the CAM layer (composed of a single layer containing CAM particles with low average particle strength) of the secondary battery in Example 8 had the most particle cracking in the CAM layer rolling step. Among the secondary batteries of Examples 1 to 12, the secondary battery of Example 9 exhibited the lowest energy density. This may be because the CAM layer (composed of a single layer containing CAM particles with high average particle strength) of the secondary battery in Example 9 had a low CAM particle fillability. The secondary battery of Example 10 exhibited the second-most gas generation amount after Example 8. This may be because the second layer (where the second CAM particles lack coating elements) exhibited an increase in particle cracking in the CAM layer rolling step due to insufficient particle strength, and decrease in resistance to side reactions involving gas generation. The secondary battery of Example 11 exhibited the third-most gas generation amount after Examples 8 and 10. This may be because the insufficient coating element content in the second CAM particles in the second layer (where the coating element content in the second CAM particles is the same as that in the first CAM particles in the first layer) induced insufficient particle strength, leading to increased particle cracking in the CAM layer rolling step. The secondary battery of Example 12 also exhibited the third-most gas generation amount after Examples 8 and 10, similarly to the secondary battery of Example 11. This may be because the second CAM particles in the second layer of the CAM layer in the secondary battery of the Example 12 had a low average sphericity and insufficient particle slipperiness, and therefore the effective load on the particles in the CAM layer rolling step is increased, leading to increased particle cracking.

In contrast, the secondary batteries of Examples 1 to 7 achieved both high energy density and suppressed gas generation amount in a high-temperature storage test. This may be because of contribution of the following conditions in complexity: the press cracking of the second CAM particles in the CAM layer rolling step is suppressed because of a higher average particle strength of the second CAM particles in the second layer than of the first CAM particles in the first layer; the slipperiness between the second CAM particles in the CAM layer rolling step is ensured because of a higher average sphericity of the second CAM particles; the cushioning function of the first layer in the CAM layer rolling step is exhibited because the first CAM particles in the first layer have lower average particle strength and greater flexibility than the second CAM particles in the second layer; and the first CAM particles are more easily deformed and increased in fillability by a press load than the second CAM particles.

As described above, the specific aspects of the technology disclosed herein include configurations described in each item below.

### Item 1:

A secondary battery including:
a cathode, an anode, and a nonaqueous electrolytic solution, in which
the cathode includes a current collector and a cathode active material layer on the current collector,
the cathode active material layer includes a first layer and a second layer, the first layer being located between the current collector and the second layer,
the first layer includes first cathode active material particles,
the second layer includes second cathode active material particles,
the second cathode active material particles have an average particle strength higher than that of the first cathode active material particle and 190 MPa or higher and
the second cathode active material particles have an average sphericity of 0.95 or higher.

### Item 2:

The secondary battery according to Item 1, in which the first cathode active material particles have an average particle strength of 160 MPa or lower.

### Item 3:

The secondary battery according to Item 1 or 2, in which the second cathode active material particle has a surface layer portion enriched with at least one element selected from the group consisting of Group 6 elements and Group 13 elements.

### Item 4:

The secondary battery according to any one of Items 1 to 3, in which a ratio of the element selected from the group consisting of Group 6 elements and Group 13 elements to a total amount of Ni, Co, and Mn in the second cathode active material particle is 0.8 mol % or higher and 3.0 mol % or lower.

### Item 5:

The secondary battery according to any one of Items 1 to 4, in which the selected element is tungsten.

### Item 6:

The secondary battery according to any one of Items 1 to 5, in which a ratio of the element selected from the group consisting of Group 6 elements and Group 13 elements to a total amount of Ni, Co, and Mn in the first cathode active material particle is lower than 0.8 mol %.

### Item 7:

The secondary battery according to any one of Items 1 to 6, in which a thickness ratio of the second layer to a total thickness of the cathode active material layer is 5% or higher and 65% or lower.

### Item 8:

The secondary battery according to any one of Items 1 to 7, in which the first cathode active material particles have an average particle diameter D₅₀ of 5 μm or larger and 18 μm or smaller.

### Item 9:

The secondary battery according to any one of Items 1 to 8, in which the second cathode active material particles have an average particle diameter D₅₀ of 3 μm or larger and 15 μm or smaller.

### Item 10:

The secondary battery according to any one of Items 1 to 9, in which the cathode active material constituting the first cathode active material particle and/or second cathode active material particle is a lithium composite oxide having a composition represented by a constitution formula Li(LiₐNiₓCo_{y}Mn_{z}M_{α})O₂ [wherein −0.1≤a≤0.1, 0.7≤x≤1, 0≤y≤0.3, 0≤z≤0.3, x+y+z=1, 0≤α≤0.1, and M is at least one element selected from the group consisting of B, Al, Mg, Ca, Ti, V, Cr, Ga, Zr, Nb, Mo, In, Hf, Ta, W, and Tl].

The specific examples of the present invention have been explained in detail above, but these examples are merely illustrative and do not limit the scope of claims. The technology described in claims includes variations and modifications of the specific examples illustrated above.

What is claimed is:

1. A secondary battery comprising:
a cathode, an anode, and a nonaqueous electrolytic solution, wherein
the cathode comprises a current collector and a cathode active material layer on the current collector,
the cathode active material layer comprises a first layer and a second layer, the first layer being located between the current collector and the second layer,
the first layer comprises first cathode active material particles,
the second layer comprises second cathode active material particles,
the second cathode active material particles have an average particle strength higher than that of the first cathode active material particle and 190 MPa or higher, and
the second cathode active material particles have an average sphericity of 0.95 or higher.

2. The secondary battery according to claim 1, wherein the first cathode active material particles have an average particle strength of 160 MPa or lower.

3. The secondary battery according to claim 1, wherein the second cathode active material particle has a surface layer portion enriched with at least one element selected from the group consisting of Group 6 elements and Group 13 elements.

4. The secondary battery according to claim 3, wherein a ratio of the element selected from the group consisting of Group 6 elements and Group 13 elements to a total amount of Ni, Co, and Mn in the second cathode active material particle is 0.8 mol % or higher and 3.0 mol % or lower.

5. The secondary battery according to claim 3, wherein the selected element is tungsten.

6. The secondary battery according to claim 4, wherein the selected element is tungsten.

7. The secondary battery according to claim 3, wherein a ratio of the element selected from the group consisting of Group 6 elements and Group 13 elements to a total amount of Ni, Co, and Mn in the first cathode active material particle is lower than 0.8 mol %.

8. The secondary battery according to claim 4, wherein a ratio of the element selected from the group consisting of Group 6 elements and Group 13 elements to a total amount of Ni, Co, and Mn in the first cathode active material particle is lower than 0.8 mol %.

9. The secondary battery according to claim 5, wherein a ratio of the element selected from the group consisting of Group 6 elements and Group 13 elements to a total amount of Ni, Co, and Mn in the first cathode active material particle is lower than 0.8 mol %.

10. The secondary battery according to claim 6, wherein a ratio of the element selected from the group consisting of Group 6 elements and Group 13 elements to a total amount of Ni, Co, and Mn in the first cathode active material particle is lower than 0.8 mol %.

11. The secondary battery according to claim 1, wherein a thickness ratio of the second layer to a total thickness of the cathode active material layer is 5% or higher and 65% or lower.

12. The secondary battery according to claim 1, wherein the first cathode active material particles have an average particle diameter D₅₀ of 5 μm or larger and 18 μm or smaller.

13. The secondary battery according to claim 1, wherein the second cathode active material particles have an average particle diameter D₅₀ of 3 μm or larger and 15 μm or smaller.

14. The secondary battery according to claim 1, wherein the cathode active material constituting the first cathode active material particle and/or second cathode active material particle is a lithium composite oxide having a composition represented by a constitution formula Li(LiₐNiₓCo_{y}Mn_{z}M_{α})O₂ [wherein −0.1≤a≤0.1, 0.7≤x≤1, 0≤y≤0.3, 0≤z≤0.3, x+y+z=1, 0≤α≤0.1, and M is at least one element selected from the group consisting of B, Al, Mg, Ca, Ti, V, Cr, Ga, Zr, Nb, Mo, In, Hf, Ta, W, and Tl].
